(19) United States
(12) Patent Application Publication
(10) Pub. No.: US 2002/0031160 A1
(43) Pub. Date: Mar. 14, 2002

(54) Delay compensation for magnetic compressors

(75) Inventor: Rainer Desor, Bovenden (DE)

Correspondence Address: Andrew V. Smith, Sierra Patent Group, P.O. Box 6149, Stateline, NV, 89449, US

(73) Assignee: Lambda Physik AG

(21) Appl. No.: 09/922,222

(22) Filed: Aug. 1, 2001

Related U.S. Application Data
(60) Provisional application No. 60/223,027, filed on Aug. 4, 2000.

(51) Int. Cl. H01S 3/22; H01S 3/223

(52) U.S. Cl. 372/57

(57) ABSTRACT

Method and system provide a variable delay between the external trigger pulse for a laser system and the light pulse such that the total delay is maintained at a substantially constant level and the overall delay between the external trigger pulse of the laser system and the light pulse is not effected by the HV, temperature change or other parameters such as material properties. The variable delay may be implemented with digital delay lines.

### RELATED APPLICATION

This application claims priority under 35 USC § 119 to U.S. provisional patent application No. 60/223,027 entitled “Delay Compensation for Magnetic Compressors” filed on Aug. 4, 2000.

### BACKGROUND OF THE INVENTION

1. Field of the Invention

The present invention relates to delay compensation for magnetic compressors in laser applications. In particular, the present invention relates to a method and system for providing temperature dependent delay compensation for magnetic compressors in excimer and/or molecular fluorine lasers.

2. Description of the Related Art

Magnetic compressors are widely used for applications that require short current pulses with high amplitude that exceed the specifications of commercially available semiconductor switches. For example, magnetic compressors can be found in excitation circuits for pulsed laser systems such as excimer or molecular fluorine lasers.

One disadvantage of magnetic pulse compression is that several factors influence the propagation delay through a magnetic compressor. For example, in an excitation circuit for an excimer laser, several stages of pulse compression can be used depending upon the compression factor as well as other requirements. A single compressor stage is typically made of a capacitor and a saturable inductivity that are comprised of a core made from a magnetic material and one or several windings.

The hold time, that is, the time needed to reach the saturation level and the low impedance state (referred to as switch through) is a function of the voltage across the core winding as well as other constraints such as the number of windings, the properties of the core material, and geometry, to name a few. This relationship can be seen from the following equation:

∫Udt=constant (1)

However, it is recognized herein that in application, the constant in the above relationship is not constant, but dependent upon temperature as the saturation flux of the core material is temperature dependent. Indeed, it can therefore be seen that the delay may be influenced by several parameters including the change in the operating voltage of the laser as well as heat generated from the dissipated laser pulse energy.

In particular, when the voltage applied to the compressor stages is changed from laser pulse to laser pulse, or less frequently, to maintain the output energy of the laser constant, the dependency of the delay to the applied voltage can be observed as a non-linear relationship. For example, when the operating voltage of the laser is increased, the delay will decrease as can be seen from equation (1) above, since the integral shown above is understood to be constant with respect to this relationship between operating voltage and delay time.

Moreover, with each laser pulse, energy is dissipated in the core and the windings into heat such that, depending on the repetition rate and the effectiveness of the cooling, the temperature of the magnetic compressor is likely to increase. In addition, when the laser is operated in burst mode, the temperature is likely to decrease when a pause between bursts of laser pulses occurs. The change in the temperature in turn, affects the delay in the following manner. First, the saturation flux of the core material decreases with increasing temperature, and vice-versa, which, in turn, will drive the core earlier into saturation and the delay will decrease in the range of approximately 40 ns/° K.

Additionally, the capacity of the ceramic compressor capacitors decreases by approximately 0.5%/° K, thus increasing the voltage according to the equation set forth below:

E=(C/2)*U²=constant (2)

such that

U=constant*(1/C)^{½} (3)

In the above, the main storage capacitor is taken to be a metal foil capacitor with a very small temperature coefficient (i.e., less than 0.01%/° K), and the stored energy is taken as constant at a fixed charging voltage and independent of the temperature.

Indeed, it is recognized herein that the temperature dependence of the ceramic capacitors and/or saturable cores of a pulser circuit of a discharge circuit for an excimer and/or molecular fluorine laser can have a substantial influence on the delay due to the voltage changes by the capacitance modification. As can be seen from equations (1) and (3) above, thermally induced changes in capacitance can affect changes in charging voltage, and in turn, can affect changes in the delay. More specifically, the primary condenser may be a paper capacitor which does not indicate a substantial temperature dependence of the capacity, and thus, a loss of capacity of the ceramic capacitors leads to a rise in voltage, which then shortens the delay.

In general, a temperature dependent delay compensation circuit for a laser pulse circuit takes into account the temperature dependence of the delay due to the temperature fluctuations of the ceramic capacitors of the pulse compression stages of the pulser circuit. For instance, U.S. Pat. No. 6,016,325 discloses taking into account the temperature dependence of the saturation times of the saturable cores of the magnetic switch inductor elements of the circuit. The temperature of the cores is measured, and a delay is calculated based on the measured temperature, taking into account only the dependence of the saturation times of the saturable cores with temperature.

### SUMMARY OF THE INVENTION

In view of the foregoing, a method for providing a substantially constant propagation delay between a trigger pulse and a light pulse of a discharge circuit for an excimer or molecular fluorine gas discharge laser system is provided including operating the excimer or molecular fluorine laser system, measuring a temperature corresponding to a temperature of a magnetic compressor including at least one stage capacitor of the discharge circuit, and calculating a corrected delay offset value including a delay dependence corresponding to a capacitance dependence of the at least one stage capacitor on the measured temperature. The propagation delay between the trigger pulse and the light pulse including the corrected offset value is approximately a predetermined propagation delay.

A discharge circuit for an excimer or molecular fluorine laser system including a substantially constant propagation delay between a trigger pulse and a light pulse is also provided including a high voltage control board for controlling delay lines which control the propagation delay, a switch trigger, a switch, a high voltage power supply, one or more pulse compression stages including a stage capacitor and a stage inductor, a temperature circuit for obtaining a temperature value corresponding to a temperature of the one or more pulse compression stages, and a laser controller for receiving the temperature value, calculating a corrected delay offset value including a delay dependence corresponding to a capacitance dependence of the one or more stage capacitors on the measured temperature, the corrected offset value for use by the high voltage control board for controlling the propagation delay, so that the propagation delay between the trigger pulse and the light pulse including the corrected offset value is approximately a predetermined propagation delay.

An excimer or molecular fluorine laser system including a substantially constant propagation delay between a trigger pulse and a light pulse is also provided including a discharge tube filled with a gas mixture including at least including a halogen containing species and a buffer gas, multiple electrodes within the discharge tube, a resonator for generating a laser beam, a laser controller, and a discharge circuit for supplying electrical pulses to the multiple electrodes. The discharge circuit includes a high voltage control board for controlling delay lines which control the propagation delay, a switch trigger, a switch, a high voltage power supply, one or more pulse compression stages including a stage capacitor and a stage inductor, and a temperature circuit for obtaining a temperature value corresponding to a temperature of the one or more pulse compression stages. The laser controller is configured to receive the temperature value, calculate a corrected delay offset value including a delay dependence corresponding to a capacitance dependence of the one or more stage capacitors on the measured temperature, the corrected offset value for use by the high voltage control board for controlling the propagation delay, so that the propagation delay between the trigger pulse and the light pulse including the corrected offset value is approximately a predetermined propagation delay.

These and other features and advantages of the present invention will be understood upon consideration of the following detailed description of the invention and the accompanying drawings.

### BRIEF DESCRIPTION OF THE DRAWINGS

FIG. 1 schematically shows a high voltage power supply and pulse compression circuit according to a preferred embodiment.

FIG. 2 illustrates a block diagram of the delay compensation system in accordance with a preferred embodiment.

FIG. 3 is a flowchart illustrating delay compensation in accordance with the preferred embodiment.

FIG. 4 is a graphical illustration of a delay—temperature relationship for capacitors and core of a discharge circuit according to a preferred embodiment.

FIG. 5 schematically illustrates an excimer or molecular fluorine laser system according to a preferred embodiment.

### INCORPORATION BY REFERENCE

The following references are hereby incorporated by reference into the present application, and are particularly incorporated by reference into the detailed description of the preferred embodiments as disclosing alternative arrangements of features or elements not otherwise set forth in detail below: German Patent Application DE 38 42 492, U.S. Pat. No. 6,005,880, U.S. Pat. No. 6,020,723, U.S. Pat. No. 5,729,562, U.S. Pat. No. 6,016,325, and U.S. patent application Ser. Nos. 09/858,147 and 09/838,715, which are assigned to the same assignee as the present application, the disclosures of each of which are incorporated herein by reference for all purposes.

### DETAILED DESCRIPTION OF THE PREFERRED EMBODIMENTS

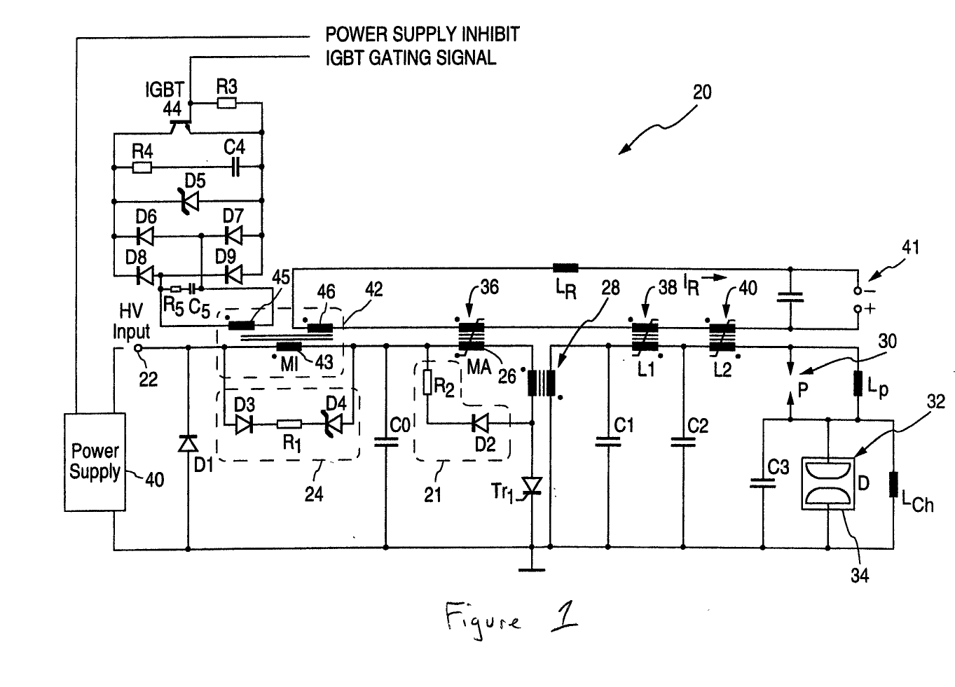

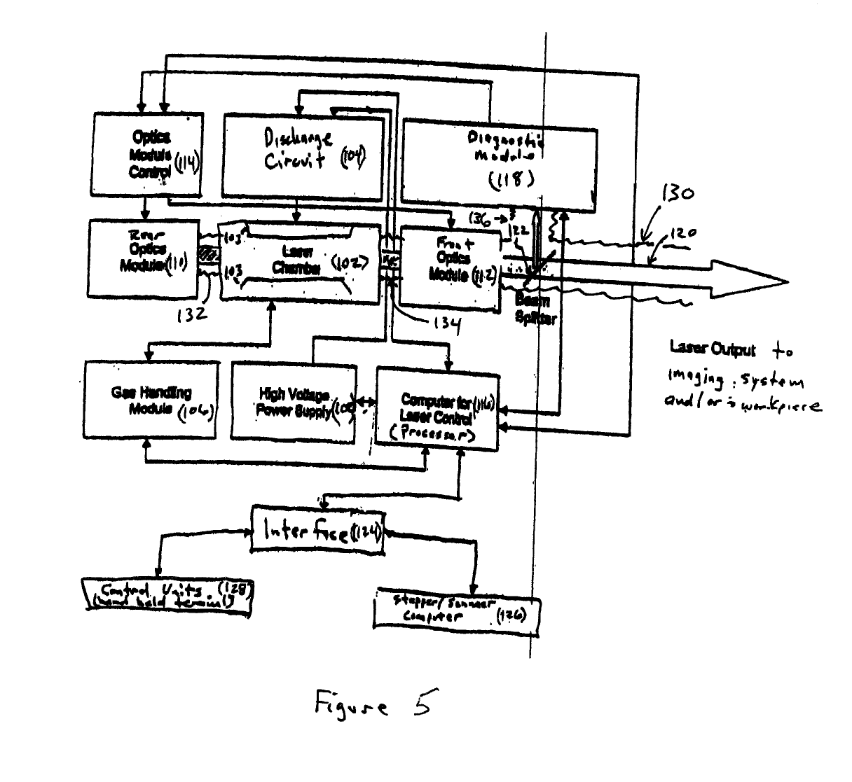

An all-solid-state switched pulser (ASSP) 20 constructed in accordance with a preferred embodiment for the excitation of excimer or molecular fluorine lasers will now be discussed. A preferred overall excimer or molecular fluorine laser system is set forth below with reference to FIG. 5. The circuit diagram of the pulser 20 is shown in FIG. 1. Initially the primary storage capacitor C₀ is charged by a switched mode power supply 40, connected to the high voltage input terminal 22. The HV input 22 is shown connected to the primary storage capacitor C₀ through the primary winding 43 of a magnetic switch controlled isolator (MI) 42, which may be excluded from other embodiments. When the desired charging voltage on C₀ has been reached, solid state switch Tr₁, is triggered and the energy stored in C₀ is resonantly transferred through the magnetic assist (MA) 26 and the pulse transformer 28 to capacitor C₁. The switched voltage in the primary loop of the pulse transformer 28 is of the order of 2 kV, which is stepped up on the secondary winding to 20 kV, which illustrates a voltage level that may be used to switch the laser.

The MA 26 shown includes a saturable inductor, which is initially reverse biased to provide a hold-off time during which the current flow through the switch Tr₁ is delayed to enable carrier diffusion spreading. This results in an increased current rise capability of the switch Tr₁ when MA is driven into saturation, allowing the full current to flow. The MA delays the current flow by virtue of the fact that it, in its unsaturated state, initially introduces a large inductance in series with the switch Tr₁. It then goes into saturation, allowing a large current flow through its small saturated inductance. The primary pulse transfer time is of the order of 4 μs which is reduced, as shown, by two pulse compression stages, including C₁-L₁-C₂ and C₂-L₂-C₃, to a pulse time of 100 ns, resulting in a voltage rise time over the discharge electrodes of 100 ns. The laser is preionized during the charging phase of capacitor C₃ by a preionizer 30, which may be a corona, sliding surface or spark gap preionizer 30, which carries the charging current. The fast rising voltage pulse on C₃ breaks down the discharge gap 34 between a pair of elongated main discharge electrodes of the laser 32 and the energy stored on C₃ is deposited into the discharge gap 34. The inductors L_{Ch} and L_{P} are used for providing a current path for the leakage current through inductors L₁ and L₂ used to drive L₁ and L₂ into saturation. L_{Ch} is also used to ensure that the capacitor C₃ returns to ground potential after a discharge.

Imperfect impedance matching between the pulse compression circuit and the discharge gap 34 may result in voltage reversal on C₃, which is transmitted through the pulse compressor and pulse transformer 28 in reverse direction, causing in time succession the voltages on C₂, C₁ and C₀ to be inverted. The snubbing circuit 21 on the pulse transformer primary loop, including of D₂ and R₂ will connect a negative voltage on C₀ directly to the switch Tr₁ and will protect the switch Tr₁ against load faults by absorbing part of the reflected energy which could otherwise result in catastrophic failure of the switch Tr₁.

The MA and inductors L₁ and L₂ are reset into reverse saturation by a dc bias current I_{R} through auxiliary secondary reset windings 36, 38, and 40. The polarity indications on MA, L₁ and L₂ inductors indicate the current flow directions The polarity of MA is different from that of L₁ and L₂ since the pulse transformer 28 inverts the positive polarity as indicated on the primary and secondary windings of the pulse transformer 28. (The polarity indications, are used in a manner consistent with standard practice. Specifically, polarity indications on the transformer symbols indicate the relationship between current flow in one winding and the induced current in the second winding.) The I._{R} current is supplied by the biasing circuit 41. The biasing current is used for the correct operation of the pulse compressor in forward direction, while the compressor is automatically biased for correct operation in the reverse direction. Such biasing is well known in the art. See Melville, 1951, “The use of saturable reactors as discharge devices for pulse generators.”

The negative voltage building up on C₀ can be partly due to energy reflected back from the preionizer 30, the discharge gap 34 and a mismatch between C₀ and C₁. Negative voltages of typically a few hundred volts are reached on C₀. A negative voltage on C₀ is desirable because this negative voltage aids in the commutation of the switch Tr₁.

However, the inverse voltage on C₀, on the power supply 40 side may cause a positive current through the components of the power supply connected to the input terminal 22 which partially discharges C₀. This current is preferably limited in order to avoid overloading of the components 6f the power supply 40.

The current could be reduced to a safe value by introducing a charging and isolation resistor between power supply and C₀. This, however, would cause high losses during the charging cycle. Various combinations of charging inductors and parallel resistors could also be employed but it was found that a charging inductor of a suitable value to protect the power supply, can interfere with the voltage regulation of the power supply, resulting in poor shot to shot voltage stability. Even a remote voltage sensor on C₀ tends not to improve voltage regulation because of the high impedance introduced between power supply and capacitor C₀ which prevents fast capacitor charging required for kHz operation. The ideal charging element will have a low impedance during the charging cycle, reducing charging losses and enabling voltage regulation, and a high impedance during the pulsing cycle, effectively isolating power supply and load.

During the primary energy transfer from C₀ to C₁, the voltage on C₀ is inverted to a negative voltage of a few hundred volts. This takes place from about 0 to 50 μs. The negative voltage on C₀ appears over the primary winding 43 of the reverse biased MI 42, if used, and the switch Tr₁.

The laser controller (not shown) switches the IGBT 44 to the on-state slightly before the removal of the inhibit signal from the power supply, enabling the charging cycle. The inhibit signal is generated in the control electronics. Since the time duration during which the inhibit signal is applied to the power supply is significantly longer than that necessary for commutation of Tr₁, a fixed timing, independent of repetition rate, can be used. The IGBT 44 now effectively short-circuits the secondary winding 45 of the MI 42 so that the power supply 40 only sees the small leakage inductance of the primary winding 43 of approximately 50 μH or less which does not impede the charging process. The snubber circuit 24, diode D₅, and the RC-combination C₅, R₅ may be used to protect the IGBT 44 from over voltage spikes. D₆-D₉ may be used as a bridge rectifier to ensure always the correct polarity for the IGBT 44. The resistors R₃ and R₄ and capacitor C₄ protect the IGBT 44. The Diode D₁ is in parallel to the power supply to ensure that the inverted voltage on C₀ does not cause a large forward current from the power supply, which could damage its output diodes.

An alternative embodiment of the pulse transformer 28 may have an auxiliary third winding with five turns, as shown in U.S. Pat. No. 6,020,723, which is hereby incorporated by reference. A voltage clamping circuit may be connected across this third winding to serve to absorb part of the reflected energy which in the case of load failure could damage switch Tr₁.

Negative voltage snubbing of C₀ has often been carried out with dissipative elements thereby wasting the energy stored in the negative charge of C₀ (See, A. L. Keet and M. Groeneboom, 1989, “High Voltage Solid-State Pulser for High Repetition Rate Gas Laser,” EPE conference, Aachen; and U.S. Pat. No. 5,177,754, “Magnetic Compression Laser Driving Circuit”, which are each hereby incorporated by reference). Power supply pulser isolation has also been carried out using series charging inductors or resistors. Additional high voltage switches may also be inserted between power supply and pulser. Accurate control of the negative voltage phase on C₀ to aid switch commutation is generally a complex issue, especially under high repetition rate operation of the laser.

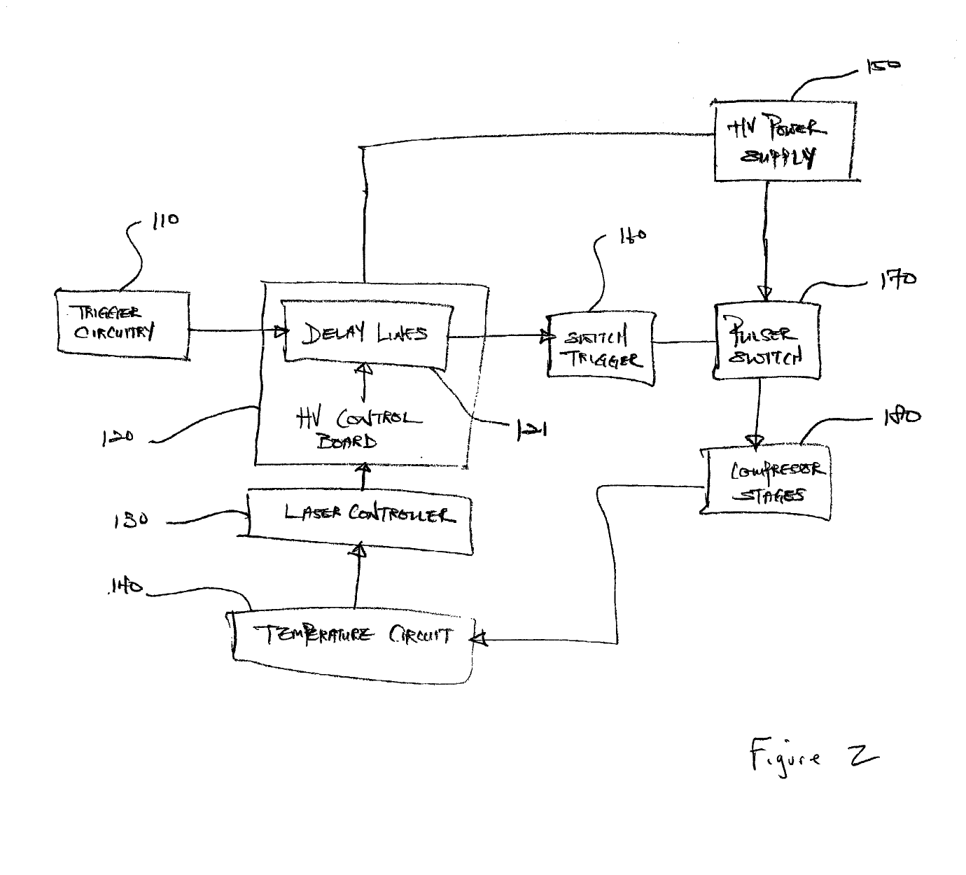

FIG. 2 illustrates a block diagram of the delay compensation system in accordance with a preferred embodiment. Referring to FIG. 2, there is provided a variable delay unit 120 provided between a trigger circuitry 110 and pulser switch 170. More specifically, to determine an accurate delay compensation according to particular applications, delay dependencies are measured and delay lines 121 are programmed with the inverse function to maintain the total delay as a constant. In one approach, the voltage dependency may be automatically measured with an external computer system by changing the HV in small steps in a predetermined applicable range and then measuring the related delay with an oscilloscope which may be configured to communicate with a computer or the like. Thereafter, software loaded on the computer communicating with the oscilloscope may be configured to generate pairs of HV and delays, and to search for the largest delay value. From the largest delay value, each actual measured delay value may be subtracted, resulting in the delay values for the delay lines 121 for each measured HV. These determined data pairs may then be converted into a predetermined data format for the laser controller 130 and stored therein as a data file, for example.

More specifically, in one embodiment, the data file may be installed in the laser controller 130 and downloaded onto the HV control board 120 as a look-up table. As can be seen, the HV control board 120 may be configured to include the delay lines 121 in one embodiment. Since the HV control board 120 knows the required HV value for each laser pulse, in one aspect, the HV control board 120 may be configured to transmit the HV value to the power supply 150 and to load the corresponding delay values onto the delay lines 121. The switch trigger 160 in the pulsed power module shown in FIG. 2 may be configured to be guided through the delay lines 121 to add the respective delays, such that the total delay between trigger circuitry 110 and the pulser switch 170 is maintained substantially constant. This approach is particularly suitable since the HV value may change from laser pulse to each successive laser pulse.

Since the temperature change is relatively slow, the temperature compensation does not have to be as fast as the HV compensation. In one embodiment, the temperature of the cores and capacitors is measured by temperature circuit 140 at every five second interval. The required change in the delay is then added as offset to the delay table and downloaded to the HV control board 120 to replace or update the look-up table loaded therein.

In the manner described above, in accordance with one embodiment herein, delay compensation for magnetic compressors in a pulsed power module may be provided without employing A/D converters nor measuring the HV.

Indeed, since the laser controller 130 commands the HV power supply 150 by a digital value and loads the delay lines 121 with a digital value representing the required delay for compensation at the particular HV, the process may be performed without measuring the HV and without using A/D converters. Moreover, in the approach, a pulser specific delay table may be generated which compensates for variations in the materials such as ceramic.

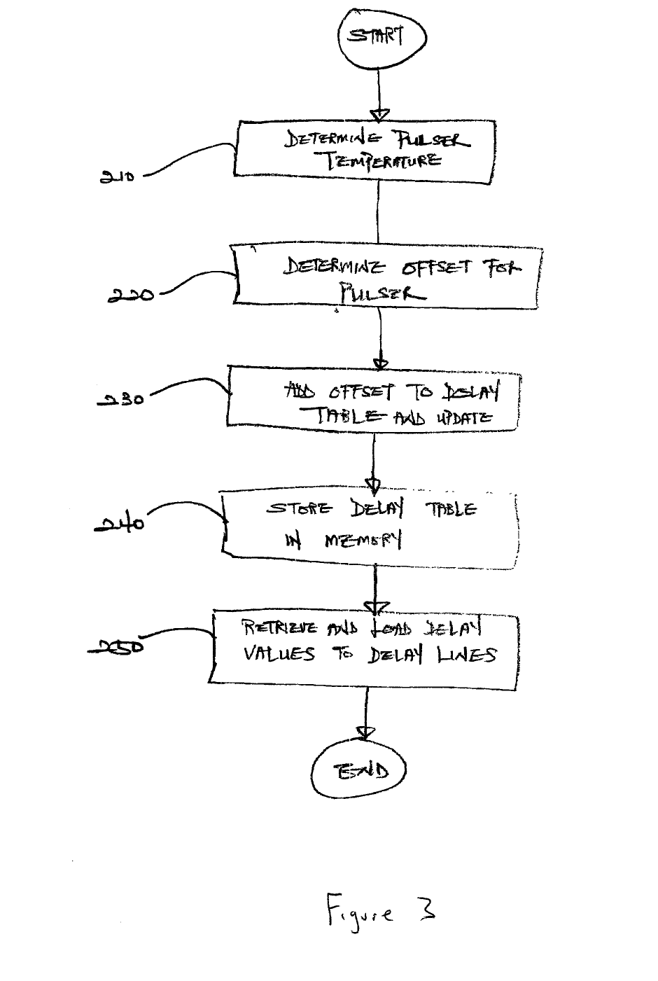

FIG. 3 is a flowchart illustrating delay compensation in accordance with a preferred embodiment. Referring to FIG. 3, at step 210, the pulser temperature is determined, for example, by the temperature circuit 140 of FIG. 2. Thereafter at step 220, an offset for the pulser is determined. In one aspect, the offset for the pulser at step 220 is determined based on the temperature dependence of the ceramic capacitors on the delay.

At step 230, the offset determined at step 220 is added to the delay table which, in one embodiment, may be in the format of a data file as a look-up table and stored in a storage device accessible by laser controller 130 of FIG. 2. More specifically, with the determined offset, the look-up table is updated in laser controller 130 and the updated look-up table is loaded for storage in memory such as a random access memory (RAM) in HV control board 120 of FIG. 2. Thereafter, the delay lines 121 are loaded with the delay values at step 250 retrieved from the memory in HV control board 120.

In this manner, in one embodiment, to maintain the delay between the external trigger pulse for a laser system and the light pulse constant and not varied by the HV, temperature or other parameters (for example, related to the material properties), the delay change may be compensated by adding a variable delay between the trigger pulse and the switch which initiates the pulse compression. Indeed, using digital delay lines, as discussed above, the variable delay in this manner may be controlled by the voltage and the temperature (or other impacting parameters) such that the total delay is maintained at a substantially constant level.

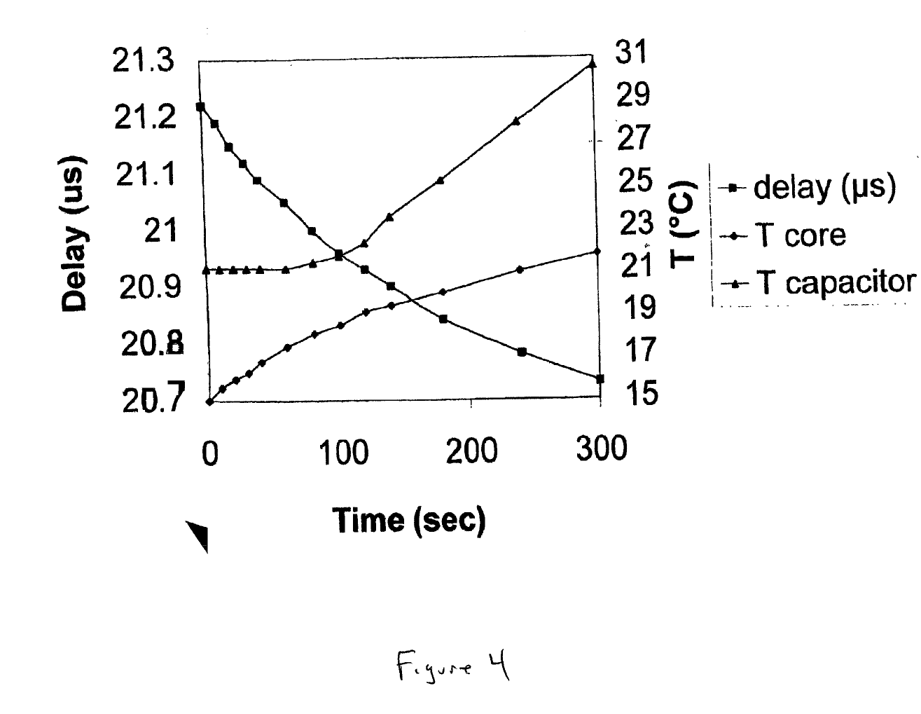

FIG. 4 is a graphical illustration of the delay—temperature dependent relationship for a discharge circuit according to a preferred embodiment. Referring to FIG. 4, a typical temperature change after pulser start for the ceramic capacitors and in close vicinity of the cores and the resulting delay at constant HV is shown.

As discussed above, it is desired that in many laser applications, especially in lithography, the delay between the external trigger pulse for the laser and the light pulse be constant, and not changed by the HV, the temperature or any other parameters. Accordingly, in the manner described above, the various embodiments of the present invention provide methods and system for compensating the delay change by adding a variable delay between the trigger pulse and the pulser switch 170 of FIG. 2 which initiates the pulse compression. The variable delay is controlled by the voltage and the temperature or other parameters in such a manner that the total delay is maintained substantially constant. In one aspect, the variable delay may be implemented using the digital delay lines 121 of FIG. 2.

### General Description of Overall Laser System

FIG. 5 schematically illustrates an overall excimer or molecular fluorine laser system according to a preferred embodiment. Referring to FIG. 5, an excimer or molecular fluorine laser system is schematically shown according to a preferred embodiment. The preferred gas discharge laser system may be a VUV laser system, such as a molecular fluorine (F₂) laser system, for use with a vacuum ultraviolet (VUV) lithography system, or may be a DUV laser system such as a KrF or ArF laser system. Alternative configurations for laser systems for use in such other industrial applications as TFT annealing, photoablation and/or micromachining, e.g., include configurations understood by those skilled in the art as being similar to and/or modified from the system shown in FIG. 5 to meet the requirements of that application. For this purpose, alternative DUV or VUV laser system and component configurations are described at U.S. patent applications Ser. Nos. 09/317,695, 09/130,277, 09/244,554, 09/452,353, 09/512,417, 09/599,130, 09/694,246, 09/712,877, 09/574,921, 09/738,849, 09/718,809, 09/629,256, 09/712,367, 09/771,366, 09/715,803, 09/738,849, 60/202,564, 60/204,095, 09/741,465, 09/574,921, 09/734,459, 09/741,465, 09/686,483, 09/715,803, and 09/780,124, and U.S. Pat. Nos. 6,005,880, 6,061,382, 6,020,723, 5,946,337, 6,014,206, 6,157,662, 6,154,470, 6,160,831, 6,160,832, 5,559,816, 4,611,270, 5,761,236, 6,212,214, 6,154,470, and 6,157,662, each of which is assigned to the same assignee as the present application and is hereby incorporated by reference.

The system shown in FIG. 5 generally includes a laser chamber 102 (or laser tube including a heat exchanger and fan for circulating a gas mixture within the chamber 102 or tube) having a pair of main discharge electrodes 103 connected with a solid-state pulser module 104, and a gas handling module 106. The gas handling module 106 has a valve connection to the laser chamber 102 so that halogen, rare and buffer gases, and preferably a gas additive, may be injected or filled into the laser chamber, preferably in premixed forms (see U.S. patent application Ser. No. 09/513,025, which is assigned to the same assignee as the present application, and U.S. Pat. No. 4,977,573, which are each hereby incorporated by reference) for ArF, XeCl and KrF excimer lasers, and halogen and buffer gases, and any gas additive, for the F₂ laser. For the high power XeCl laser, the gas handling module may or may not be present in the overall system. The solid-state pulser module 104, including preferably an IGBT switch, and alternatively a thyrister or other solid state switch, is powered by a high voltage power supply 108. A thyratron pulser module may alternatively be used. The laser chamber 102 is surrounded by optics module 110 and optics module 112, forming a resonator. The optics module may include only a highly reflective resonator reflector in the rear optics module 110 and a partially reflecting output coupling mirror in the front optics module 112, such as is preferred for the high power XeCl laser. The optics modules 110 and 112 may be controlled by an optics control module 114, or may be alternatively directly controlled by a computer or processor 116, particular when line-narrowing optics are included in one or both of the optics modules 110, 112, such as is preferred when KrF, ArF or F₂ lasers are used for optical lithography.

The processor 116 for laser control receives various inputs and controls various operating parameters of the system. A diagnostic module 118 receives and measures one or more parameters, such as pulse energy, average energy 10 and/or power, and preferably wavelength, of a split off portion of the main beam 120 via optics for deflecting a small portion of the beam toward the module 118, such as preferably a beam splitter module 122. The beam 120 is preferably the laser output to an imaging system (not shown) and ultimately to a workpiece (also not shown) such as particularly for lithographic applications, and may be output directly to an application process. The laser control computer 116 may communicate through an interface 124 with a stepper/scanner computer, other control units 126, 128 and/or other external systems.

### Laser Chamber

The laser chamber 102 contains a laser gas mixture and includes one or more preionization electrodes (not shown) in addition to the pair of main discharge electrodes 103. Preferred main electrodes 103 are described at U.S. patent application Ser. No. 09/453,670 for photolithographic applications, which is assigned to the same assignee as the present application and is hereby incorporated by reference, and may be alternatively configured, e.g., when a narrow discharge width is not preferred. Other electrode configurations are set forth at U.S. Pat. Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. Preferred preionization units are set forth at U.S. patent application Ser. Nos. 09/692,265 (particularly preferred for KrF, ArF, F₂ lasers), 09/532,276 and 09/247,887, each of which is assigned to the same assignee as the present application, and alternative embodiments are set forth at U.S. Pat. Nos. 5,337,330, 5,818,865 and 5,991,324, all of the above patents and patent applications being hereby incorporated by reference.

The laser chamber 102 is sealed by windows transparent to the wavelengths of the emitted laser radiation 120. The windows may be Brewster windows or may be aligned at another angle, e.g., 5°, to the optical path of the resonating beam. One of the windows may also serve to output couple the beam or as a highly reflective resonator reflector on the opposite side of the chamber 102 as the beam is outcoupled.

### Solid State Pulser Module

Many preferred features of the solid state pulser module according to a preferred embodiment have been described above with reference to FIGS. 1-4, and some additional details and/or alternative embodiments are provided here and within references cited here. The solid-state or thyratron pulser module 104 and high voltage power supply 108 supply electrical energy in compressed electrical pulses to the preionization and main electrodes 103 within the laser chamber 102 to energize the gas mixture. Components of the preferred pulser module and high voltage power supply may be described at U.S. patent applications Ser. Nos. 09/640,595, 60/198,058, 60/204,095, 09/432,348 and 09/390,146, and 60/204,095, and U.S. Pat. Nos. 6,005,880, 6,226,307 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872, 6,151,346 and 5,729,562, each of which is hereby incorporated by reference.

### Laser Resonator

The laser resonator which surrounds the laser chamber 102 containing the laser gas mixture includes optics module 110 preferably including line-narrowing optics for a line narrowed excimer or molecular fluorine laser such as for photolithography, which may be replaced by a high reflectivity mirror or the like in a laser system wherein either line-narrowing is not desired (for TFT annealling, e.g.), or if line narrowing is performed at the front optics module 112, or a spectral filter external to the resonator is used, or if the line-narrowing optics are disposed in front of the HR mirror, for narrowing the bandwidth of the output beam. For a molecular fluorine laser, optics for selecting one of multiple lines around 157 nm may be used, e.g., one or more dispersive prisms or birefringent plates or blocks, wherein additional line-narrowing optics for narrowing the selected line may be left out. The total gas mixture pressure may be preferably lower than conventional systems, e.g., lower than 3 bar, for producing the selected line at a narrow bandwidth such as 0.5 pm or less without using additional line-narrowing optics.

For the F₂ laser, line-selection optics are preferably included for selecting the main line at around λ₁=157.63094 nm and suppressing any other lines around 157 nm that may be naturally emitted by the F₂ laser. Therefore, in one embodiment, the optics module 10 has only a highly reflective resonator mirror, and the optics module 12 has only a partially reflective resonator reflector. In another embodiment, suppression of the other lines (i.e., other than λ₁) around 157 nm is performed, e.g., by an outcoupler having a partially reflective inner surface and being made of a block of birefringent material or a VUV transparent block with a coating, either of which has a transmission spectrum which is periodic due to interference and/or birefringence, and has a maximum at λ₁ and a minimum at a secondary line. In another embodiment, simple optics such as a dispersive prism or prisms may be used for line-selection only, and not for narrowing of the main line at λ₂. Other line selection embodiments are set forth at U.S. patent application Ser. Nos. 09/317,695, 09/657,396, and 09/599,130, each of which is assigned to the same assignee as the present application and is hereby incorporated by reference. The advantageous gas mixture pressure of the seed laser of the preferred embodiment enables a narrow bandwidth, e.g., below 0.5 pm, even without further narrowing of the main line at 11 using additional optics.

Optics module 112 preferably includes means for outcoupling the beam 120, such as a partially reflective resonator reflector. The beam 120 may be otherwise outcoupled such as by an intra-resonator beam splitter or partially reflecting surface of another optical element, and the optics module 112 would in this case include a highly reflective mirror. The optics control module 114 preferably controls the optics modules 110 and 112 such as by receiving and interpreting signals from the processor 116, and initiating realignment, gas pressure adjustments in the modules 110, 112, or reconfiguration procedures (see the '353, '695, '277, '554, and '527 applications mentioned above).

### Diagnostic Module

After a portion of the output beam 120 passes the outcoupler of the optics module 112, that output portion preferably impinges upon a beam splitter module 122 which includes optics for deflecting a portion of the beam to the diagnostic module 118, or otherwise allowing a small portion of the outcoupled beam to reach the diagnostic module 118, while a main beam portion 120 is allowed to continue as the output beam 120 of the laser system (see U.S. patent application Ser. Nos. 09/771,013, 09/598,552, and 09/712,877 which are assigned to the same assignee as the present invention, and U.S. Pat. No. 4,611,270, each of which is hereby incorporated by reference. Preferred optics include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 118. A holographic beam sampler, transmission grating, partially transmissive reflection diffraction grating, grism, prism or other refractive, dispersive and/or transmissive optic or optics may also be used to separate a small beam portion from the main beam 120 for detection at the diagnostic module 118, while allowing most of the main beam 120 to reach an application process directly or via an imaging system or otherwise. These optics or additional optics may be used to filter out visible radiation such as the red emission from atomic fluorine in the gas mixture from the split off beam prior to detection.

The output beam 120 may be transmitted at the beam splitter module while a reflected beam portion is directed at the diagnostic module 118, or the main beam 120 may be reflected, while a small portion is transmitted to the diagnostic module 118. The portion of the outcoupled beam which continues past the beam splitter module is the output beam 120 of the laser, which propagates toward an industrial or experimental application such as an imaging system and workpiece for photolithographic applications.

The diagnostic module 118 preferably includes at least one energy detector. This detector measures the total energy of the beam portion that corresponds directly to the energy of the output beam 120 (see U.S. Pat. Nos. 4,611,270 and 6,212,214 which are hereby incorporated by reference). An optical configuration such as an optical attenuator, e.g., a plate or a coating, or other optics may be formed on or near the detector or beam splitter module 122 to control the intensity, spectral distribution and/or other parameters of the radiation impinging upon the detector (see U.S. patent application Ser. Nos. 09/172,805, 09/741,465, 09/712,877, 09/771,013 and 09/771,366, each of which is assigned to the same assignee as the present application and is hereby incorporated by reference).

One other component of the diagnostic module 118 is preferably a wavelength and/or bandwidth detection component such as a monitor etalon or grating spectrometer (see U.S. patent applications Ser. Nos. 09/416,344, 09/686,483, and 09/791,431, each of which is assigned to the same assignee as the present application, and U.S. Pat. Nos. 4,905,243, 5,978,391, 5,450,207, 4,926,428, 5,748,346, 5,025,445, 6,160,832, 6,160,831 and 5,978,394, all of the above wavelength and/or bandwidth detection and monitoring components being hereby incorporated by reference. In accord with a preferred embodiment herein, the bandwidth and wavelength is monitored and controlled in a feedback loop including the processor 116, and the feedback loop may also include the gas handling module 106 and/or tunable optics of the resonator. The total pressure of the gas mixture in the laser tube 102 is controlled to a particular value for producing an output beam at a particular bandwidth.

Other components of the diagnostic module may include a pulse shape detector or ASE detector, such as are described at U.S. patent application Ser. Nos. 09/484,818 and 09/418,052, respectively, each of which is assigned to the same assignee as the present application and is hereby incorporated by reference, such as for gas control and/or output beam energy stabilization, or to monitor the amount of amplified spontaneous emission (ASE) within the beam to ensure that the ASE remains below a predetermined level, as set forth in more detail below. There may be a beam alignment monitor, e.g., such as is described at U.S. Pat. No. 6,014,206, or beam profile monitor, e.g., U.S. patent application Ser. No. 09/780,124, which is assigned to the same assignee, wherein each of these patent documents is hereby incorporated by reference.

### Beam Path Enclosures

Particularly for the molecular fluorine laser system, and for the ArF laser system, an enclosure 130 preferably seals the beam path of the beam 120 such as to keep the beam path free of photoabsorbing species. Smaller enclosures 132 and 134 preferably seal the beam path between the chamber 102 and the optics modules 110 and 112, respectively, and a further enclosure 136 is disposed between the beam splitter 122 and the diagnostic module 118. Preferred enclosures are described in detail in U.S. patent application Ser. Nos. 09/598,552, 09/594,892 and 09/131,580, which are assigned to the same assignee and are hereby incorporated by reference, and U.S. Pat. Nos. 6,219,368, 5,559,584, 5,221,823, 5,763,855, 5,811,753 and 4,616,908, all of which are hereby incorporated by reference.

### Processor Control

The processor or control computer 116 receives and processes values of some of the pulse shape, energy, ASE, energy stability, energy overshoot for burst mode operation, wavelength, spectral purity and/or bandwidth, among other input or output parameters of the laser system and output beam. The processor 116 also controls the line narrowing module to tune the wavelength and/or bandwidth or spectral purity, and controls the power supply and pulser module 104 and 108 to control preferably the moving average pulse power or energy, such that the energy dose at points on the workpiece is stabilized around a desired value. In addition, the computer 116 controls the gas handling module 106 which includes gas supply valves connected to various gas sources. Further functions of the processor 116 such as to provide overshoot control, energy stability control and/or to monitor input energy to the discharge, are described in more detail at U.S. patent application Ser. No. 09/588,561, which is assigned to the same assignee and is hereby incorporated by reference.

As shown in FIG. 5, the processor 116 preferably communicates with the solid-state or thyratron pulser module 104 and HV power supply 108, separately or in combination, the gas handling module 106, the optics modules 110 and/or 112, the diagnostic module 118, and an interface 124. The laser resonator which surrounds the laser chamber 102 containing the laser gas mixture includes optics module 110 including line-narrowing optics for a line narrowed excimer or molecular fluorine laser, which may be replaced by a high reflectivity mirror or the like in a laser system wherein either line-narrowing is not desired, or if line narrowing is performed at the front optics module 112, or an spectral filter external to the resonator is used for narrowing the linewidth of the output beam. Several variations of line-narrowing optics are set forth in detail below.

### Gas Mixture

The laser gas mixture is initially filled into the laser chamber 102 in a process referred to herein as a “new fills”. In such procedure, the laser tube is evacuated of laser gases and contaminants, and re-filled with an ideal gas composition of fresh gas. The gas composition for a very stable excimer or molecular fluorine laser in accord with the preferred embodiment uses helium or neon or a mixture of helium and neon as buffer gas(es), depending on the particular laser being used. Preferred gas compositions are described at U.S. Pat. Nos. 4,393,405, 6,157,162 and 4,977,573 and U.S. patent application Ser. Nos. 09/513,025, 09/447,882, 09/418,052, and 09/588,561, each of which is assigned to the same assignee and is hereby incorporated by reference into the present application. The concentration of the fluorine in the gas mixture may range from 0.003% to 1.00%, and is preferably around 0.1%. For rare gas-halide laser such as an ArF or KrF laser, a rare gas concentration of between 0.03% to 10%, and preferably around 1%, is used. An additional gas additive, such as a rare gas or otherwise, may be added for increased energy stability, overshoot control and/or as an attenuator as described in the Ser. No. 09/513,025 application incorporated by reference above. Specifically, for the F₂-laser, an addition of xenon, krypton and/or argon may be used. The concentration of xenon or argon in the mixture may range from 0.0001% to 0.1%. For an ArF-laser, an addition of xenon or krypton may be used also having a concentration between 0.0001% to 0.1%. For the KrF laser, an addition of xenon or argon may be used also having a concentration between 0.0001% to 0.1%. Although in some places herein, the preferred embodiments are particularly drawn to use with a F₂ laser, some gas replenishment actions are described for gas mixture compositions of other systems such as ArF, KrF, and XeCl excimer lasers, wherein the ideas set forth herein may also be advantageously incorporated into those systems.

Also, the gas composition for the KrF, ArF or F₂ laser in the above configurations uses either helium, neon, or a mixture of helium and neon as a buffer gas. For the KrF laser, the buffer gas is preferably at least mostly neon. The concentration of fluorine in the buffer gas preferably ranges from 0.003% to around 1.0%, and is preferably around 0.1%. However, if the total pressure is reduced for narrowing the bandwidth, then the fluorine concentration may be higher than 0.1 %, such as may be maintained between 1 and 7 mbar, and more preferably around 3-5 mbar, notwithstanding the total pressure in the tube or the percentage concentration of the halogen in the gas mixture. The rare gas concentration may be around 1% in the gas mixture, and may be larger if reduced total pressures are used. The addition of a trace amount of xenon, and/or argon, and /or oxygen, and/or krypton and/or other gases (see the '025 application) may be used for increasing the energy stability, burst control, and/or output energy of the laser beam. The concentration of xenon, argon, oxygen, or krypton in the mixture may range from 0.0001% to 0.1%, and would be preferably significantly below 0.1%. Some alternative gas configurations including trace gas additives are set forth at U.S. patent application Ser. No. 09/513,025 and U.S. Pat. No. 6,157,662, each of which is assigned to the same assignee and is hereby incorporated by reference.

Preferably, a mixture of 5% F₂ in Ne with He as a buffer gas is used, although more or less He or Ne may be used. The total gas pressure is advantageously adjustable between 1500 and 4000 mbar for adjusting the bandwidth of the laser. The partial pressure of the buffer gas is preferably adjusted to adjust the total pressure, such that the amount of molecular fluorine in the laser tube is not varied from an optimal, pre-selected amount. The bandwidth is shown to advantageously decrease with decreased He and/or Ne buffer gas in the gas mixture. Thus, the partial pressure of the He and/or Ne in the laser tube is adjustable to adjust the bandwidth of the laser emission.

### Gas Mixture Replenishment

Halogen gas injections, including micro-halogen injections of, e.g., 1-3 milliliters of halogen gas, mixed with, e.g., 20-60 milliliters of buffer gas or a mixture of the halogen gas, the buffer gas and a active rare gas for rare gas-halide excimer lasers, per injection for a total gas volume in the laser tube 102 of, e.g., 100 liters, total pressure adjustments and gas replacement procedures may be performed using the gas handling module 106 preferably including a vacuum pump, a valve network and one or more gas compartments. The gas handling module 106 receives gas via gas lines connected to gas containers, tanks, canisters and/or bottles. Some preferred and alternative gas handling and/or replenishment procedures, other than as specifically described herein (see below), are described at U.S. Pat. Nos. 4,977,573, 6,212,214 and 5,396,514 and U.S. patent application Ser. Nos. 09/447,882, 09/418,052, 09/734,459, 09/513,025 and 09/588,561, each of which is assigned to the same assignee as the present application, and U.S. Pat. Nos. 5,978,406, 6,014,398 and 6,028,880, all of which are hereby incorporated by reference. A xenon gas supply may be included either internal or external to the laser system according to the '025 application, mentioned above.

Total pressure adjustments in the form of releases of gases or reduction of the total pressure within the laser tube 102 may also be performed. Total pressure adjustments may be followed by gas composition adjustments if it is determined that, e.g., other than the desired partial pressure of halogen gas is within the laser tube 102 after the total pressure adjustment. Total pressure adjustments may also be performed after gas replenishment actions, and may be performed in combination with smaller adjustments of the driving voltage to the discharge than would be made if no pressure adjustments were performed in combination.

Gas replacement procedures may be performed and may be referred to as partial, mini- or macro-gas replacement operations, or partial new fill operations, depending on the amount of gas replaced, e.g., anywhere from a few milliliters up to 50 liters or more, but less than a new fill, such as are set forth in the Ser. No. 09/734,459 application, incorporated by reference above. As an example, the gas handling unit 106 connected to the laser tube 102 either directly or through an additional valve assembly, such as may include a small compartment for regulating the amount of gas injected (see the '459 application), may include a gas line for injecting a premix A including 1% F₂:99% Ne or other buffer gas such as He, and another gas line for injecting a premix B including 1% rare gas:99% buffer gas, for a rare gas-halide excimer laser, wherein for a F₂ laser premix B is not used. Another line may be used for total pressure additions or reductions, i.e., for flowing buffer gas into the laser tube or allowing some of the gas mixture in the tube to be released, possibly accompanying halogen injections for maintaining the halogen concentration. Thus, by injecting premix A (and premix B for rare gas-halide excimer lasers) into the tube 102 via the valve assembly, the fluorine concentration in the laser tube 102 may be replenished. Then, a certain amount of gas may be released corresponding to the amount that was injected to maintain the total pressure at a selected level. Additional gas lines and/or valves may be used for injecting additional gas mixtures. New fills, partial and mini gas replacements and gas injection procedures, e.g., enhanced and ordinary micro-halogen injections, such as between 1 milliliter or less and 3-10 milliliters, and any and all other gas replenishment actions are initiated and controlled by the processor 116 which controls valve assemblies of the gas handling unit 106 and the laser tube 102 based on various input information in a feedback loop. These gas replenishment procedures may be used in combination with gas circulation loops and/or window replacement procedures to achieve a laser system having an increased servicing interval for both the gas mixture and the laser tube windows.

The halogen concentration in the gas mixture is maintained constant during laser operation by gas replenishment actions by replenishing the amount of halogen in the laser tube for the molecular fluorine, ArF, KrF or other excimer laser herein, such that these gases are maintained in a same predetermined ratio as are in the laser tube 102 following a new fill procedure. In addition, gas injection actions such as μHIs as understood from the '882 application, mentioned above, may be advantageously modified into micro gas replacement procedures, such that the increase in energy of the output laser beam may be compensated by reducing the total pressure. In contrast, or alternatively, conventional laser systems would reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube 102.

Advantageously, the gas procedures set forth herein permit the laser system to operate within a very small range around HVₒₚₜ, while still achieving average pulse energy control and gas replenishment, and increasing the gas mixture lifetime or time between new fills (see U.S. patent application Ser. No. 09/780,120, which is assigned to the same assignee as the present application and is hereby incorporated by reference).

### Line Narrowing

A general description of the line-narrowing features of embodiments of the laser system particularly for use with photolithographic applications is provided here, followed by a listing of patent and patent applications being incorporated by reference as describing variations and features that may be used within the scope of the preferred embodiments herein for providing an output beam with a high spectral purity or bandwidth (e.g., below 1 pm and preferably 0.6 pm or less). These exemplary embodiments may be used for selecting the primary line λ₁ of the F₂ laser and/or for narrowing the linewidth of the primary line, or may be used to provide additional line narrowing as well as performing line-selection, or the resonator may include optics for line-selection and additional optics for line-narrowing of the selected line, and line-narrowing may be provided by controlling (i.e., reducing) the total pressure (see U.S. patent application No. 60/212,301, which is assigned to the same assignee and is hereby incorporated by reference). For the KrF and ArF lasers, line-narrowing optics are used for narrowing the broadband characteristic emission (e.g., around 400 pm) of each of these lasers. Exemplary line-narrowing optics contained in the optics module 110 include a beam expander, an optional interferometric device such as an etalon or otherwise as described in the Ser. No. 09/715,803 application, incorporated by reference above, and a diffraction grating, and alternatively one or more dispersion prisms may be used, wherein the grating would produce a relatively higher degree of dispersion than the prisms although generally exhibiting somewhat lower efficiency than the dispersion prism or prisms, for a narrow band laser such as is used with a refractive or catadioptric optical lithography imaging system. As mentioned above, the front optics module may include line-narrowing optics such as may be described in any of the Ser. Nos. 09/715,803, 09/738,849, and 09/718,809 applications, each being assigned to the same assignee and hereby incorporated by reference.

Instead of having a retro-reflective grating in the rear optics module 110, the grating may be replaced with a highly reflective mirror, and a lower degree of dispersion may be produced by a dispersive prism or alternatively no line-narrowing or line-selection may be performed in the rear optics module 110. In the case of using an all-reflective imaging system, the laser may be configured for semi-narrow band operation such as having an output beam linewidth in excess of 0.6 pm, depending on the characteristic broadband bandwidth of the laser, such that additional line-narrowing of the selected line would not be used, either provided by optics or by reducing the total pressure in the laser tube.

The beam expander of the above exemplary line-narrowing optics of the optics module 110 preferably includes one or more prisms. The beam expander may include other beam expanding optics such as a lens assembly or a converging/diverging lens pair. The grating or a highly reflective mirror is preferably rotatable so that the wavelengths reflected into the acceptance angle of the resonator can be selected or tuned. Alternatively, the grating, or other optic or optics, or the entire line-narrowing module may be pressure tuned, such as is set forth in the Ser. No. 09/771,366 application and the U.S. Pat. No. 6,154,470 patent, each of which is assigned to the same assignee and is hereby incorporated by reference. The grating may be used both for dispersing the beam for achieving narrow bandwidths and also preferably for retroreflecting the beam back toward the laser tube. Alternatively, a highly reflective mirror is positioned after the grating which receives a reflection from the grating and reflects the beam back toward the grating in a Littman configuration, or the grating may be a transmission grating. One or more dispersive prisms may also be used, and more than one etalon or other interferometric device may be used.

One or more apertures may be included in the resonator for blocking stray light and matching the divergence of the resonator (see the '277 application). As mentioned above, the front optics module may include line-narrowing optics (see the Ser. No. 09/715,803, 09/738,849 and 09/718,809 applications, each being assigned to the same assignee as the present application and hereby incorporated by reference), including or in addition to the outcoupler element. Depending on the type and extent of line-narrowing and/or selection and tuning that is desired, and the particular laser that the line-narrowing optics are to be installed into, there are many alternative optical configurations that may be used other than those specifically described below with respect to FIGS. 1-4. For this purpose, those shown in U.S. Pat. Nos. 4,399,540, 4,905,243, 5,226,050, 5,559,816, 5,659,419, 5,663,973, 5,761,236, 6,081,542, 6,061,382, 6,154,470, 5,946,337, 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, and any of the patent applications mentioned above and below herein, may be consulted to obtain a line-narrowing configuration that may be used with a preferred laser system herein, and each of these patent references is each hereby incorporated by reference into the present application.

Line-narrowing optics may be used for further line-narrowing in combination with line-narrowing and/or bandwidth adjustment that is performed by adjusting/reducing the total pressure in the laser chamber. For example, a natural bandwidth may be adjusted to 0.5 pm by reducing the partial pressure of the buffer gas to 1000-1500 mbar. The bandwidth could than be reduced to 0.2 pm or below using line-narrowing optics either in the resonator or external to the resonator. Exemplary line-narrowing optics are contained in the optics module 10, or the rear optics module, include a beam expander, an optional etalon and a diffraction grating, which produces a relatively high degree of dispersion, for a narrow band laser such as is used with a refractive or catadioptric optical lithography imaging system. The line-narrowing package may include a beam expander and one or more etalons followed by an HR mirror as a resonator reflector.

### Optical Materials

In all of the above and below embodiments, the material used for any dispersive prisms, the prisms of any beam expanders, etalons, laser windows and the outcoupler is preferably one that is highly transparent at wavelengths below 200 nm for the F₂ and ArF lasers, such as at the 157 nm and 193 nm output emission wavelengths of the molecular fluorine and ArF lasers, respectively. The materials are also capable of withstanding long-term exposure to ultraviolet light with minimal degradation effects. Examples of such materials are CaF₂, MgF₂, BaF₂, LiF and SrF₂, and in some cases fluorine-doped quartz may be used. Also, in all of the embodiments, many optical surfaces, particularly those of the prisms, may or may not have an antireflective coating on one or more optical surfaces, in order to minimize reflection losses and prolong their lifetime. For the KrF laser, the above materials, or other materials such as fused silica, that may be transparent around 248 nm, may be used.

### Power Amplifier

A line-narrowed oscillator, e.g., as set forth above, may be followed by a power amplifier for increasing the power of the beam output by the oscillator.

Preferred features of the oscillator-amplifier set-up may be as set forth at U.S. patent applications Ser. Nos. 09/599,130 and 60/228,184, which are assigned to the same assignee and are hereby incorporated by reference. The amplifier may be the same or a separate discharge chamber 102. An optical or electrical delay may be used to time the electrical discharge at the amplifier with the reaching of the optical pulse from the oscillator at the amplifier. The laser oscillator may have an output coupler having a transmission interference maximum at λ₁ and a minimum at λ₂, of multiple lines of emission of a molecular fluorine laser around 157 μm. The 157 nm beam may be output from the output coupler and then incident at the amplifier of this embodiment to increase the power of the beam. Thus, a very narrow bandwidth beam is achieved with high suppression of the secondary line λ₂ and high power (at least several Watts to more than 10 Watts). According to the 184 application, the oscillator may be operated at low gas mixture pressure for providing a narrow bandwidth beam, while line-narrowing optics may or may not be included. An low pressure excimer or molecular fluorine gas lamp may be used for emitting ultraviolet light that may be amplified at the amplifier, as well.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A method for providing a substantially constant propagation delay between a trigger pulse and a light pulse of a discharge circuit for an excimer or molecular fluorine gas discharge laser system, comprising the steps of:
operating the excimer or molecular fluorine laser system;
measuring a temperature corresponding to a temperature of a magnetic compressor including at least one stage capacitor of the discharge circuit;
calculating a corrected delay offset value including a delay dependence corresponding to a capacitance dependence of the at least one stage capacitor on the measured temperature, wherein the propagation delay between the trigger pulse and the light pulse including the corrected offset value is approximately a predetermined propagation delay.

2. The method of claim 1, wherein the calculating step includes the steps of:
calculating a delay offset value including the delay dependence corresponding to the capacitance dependence of the at least one stage capacitor on the measured temperature; and
adding the calculated delay offset value to a predetermined offset value to obtain the corrected offset value.

3. The method of claim 1, further comprising the step of repeating the measuring, calculating and adding steps periodically.

4. The method of claim 3, wherein a time between successive measuring, calculating and adding steps is at least one second.

5. The method of claim 1, wherein the adding step comprises the step of adding the calculated delay offset value to a table of offset values depending on input high voltage values.

6. The method of claim 5, further comprising the steps of repeating the measuring, calculating and adding steps periodically.

7. The method of claim 6, wherein a time between successive measuring, calculating and adding steps is at least one second.

8. The method of claim 1, wherein said delay offset value calculated in said calculating step further includes a delay dependence corresponding to an inductance dependence of at least one stage inductor on the measured temperature.

9. A discharge circuit for an excimer or molecular fluorine laser system including a substantially constant propagation delay between a trigger pulse and a light pulse, comprising:
a high voltage control board for controlling delay lines which control the propagation delay;
a switch trigger;
a switch;
a high voltage power supply;
one or more pulse compression stages including a stage capacitor and a stage inductor;
a temperature circuit for obtaining a temperature value corresponding to a temperature of the one or more pulse compression stages;
a laser controller for receiving the temperature value, calculating a corrected delay offset value including a delay dependence corresponding to a capacitance dependence of the one or more stage capacitors on the measured temperature, the corrected offset value for use by the high voltage control board for controlling the propagation delay, so that the propagation delay between the trigger pulse and the light pulse including the corrected offset value is approximately a predetermined propagation delay.

10. The discharge circuit of claim 9, wherein the corrected delay offset value calculation includes calculating a delay offset value including the delay dependence corresponding to the capacitance dependence of the one or more stage capacitors on the measured temperature, and adding the calculated delay offset value to a predetermined offset value

11. The discharge circuit of claim 9, wherein the temperature circuit periodically obtains new temperature values, and the laser controller periodically calculates new corrected offset values based on the new temperature values.

12. The discharge circuit of claim 11, wherein a time between successive corrected offset value calculations is at least one second.

13. The discharge circuit of claim 9, wherein the laser controller further adds the calculated delay offset value to a table of offset values depending on input high voltage values.

14. The discharge circuit of claim 13, wherein the temperature circuit periodically obtains new temperature values, and the laser controller periodically calculates new corrected offset values based on the new temperature values.

15. The discharge circuit of claim 14, wherein a time between successive corrected offset value calculations is at least one second.

16. The discharge circuit of claim 9, wherein said calculated delay offset value further includes a delay dependence corresponding to an inductance dependence of at least one stage inductor on the measured temperature.

17. The discharge circuit of claim 9, wherein the delay lines are digital delay lines.

18. An excimer or molecular fluorine laser system including a substantially constant propagation delay between a trigger pulse and a light pulse, comprising a discharge tube filled with a gas mixture including at least including a halogen containing species and a buffer gas;
multiple electrodes within the discharge tube;
a resonator for generating a laser beam;
a laser controller;
a discharge circuit for supply electrical pulses to the multiple electrodes, the discharge circuit comprising:
a high voltage control board for controlling delay lines which control the propagation delay;
a switch trigger;
a switch;
a high voltage power supply;
one or more pulse compression stages including a stage capacitor and a stage inductor; and
a temperature circuit for obtaining a temperature value corresponding to a temperature of the one or more pulse compression stages, and
wherein the laser controller is configured to receive the temperature value, calculate a corrected delay offset value including a delay dependence corresponding to a capacitance dependence of the one or more stage capacitors on the measured temperature, the corrected offset value for use by the high voltage control board for controlling the propagation delay, so that the propagation delay between the trigger pulse and the light pulse including the corrected offset value is approximately a predetermined propagation delay.

19. The laser system of claim 18, wherein the corrected delay offset value calculation includes calculating a delay offset value including the delay dependence corresponding to the capacitance dependence of the one or more stage capacitors on the measured temperature, and adding the calculated delay offset value to a predetermined offset value

20. The laser system of claim 18, wherein the temperature circuit periodically obtains new temperature values, and the laser controller is configured to periodically calculate new corrected offset values based on the new temperature values.

21. The laser system of claim 20, wherein a time between successive corrected offset value calculations is at least one second.

22. The laser system of claim 18, wherein the laser controller is further configured to add the calculated delay offset value to a table of offset values depending on input high voltage values.

23. The laser system of claim 22, wherein the temperature circuit periodically obtains new temperature values, and the laser controller is configured to periodically calculate new corrected offset values based on the new temperature values.

24. The laser system of claim 23, wherein a time between successive corrected offset value calculations is at least one second.

25. The laser system of claim 18, wherein said calculated delay offset value further includes a delay dependence corresponding to an inductance dependence of at least one stage inductor on the measured temperature.

26. The laser system of claim 18, wherein the delay lines are digital delay lines.
